(19) United States
(12) Patent Application Publication
(10) Pub. No.: US 2010/0272134 A1
(43) Pub. Date: Oct. 28, 2010

(54) Rapid Alignment Methods For Optical Packages

(76) Inventors: Douglass L. Blanding, Painted Post, NY (US); Jacques Gollier, Painted Post, NY (US); Garrett Andrew Piech, Horseheads, NY (US)

Correspondence Address: CORNING INCORPORATED, SP-TI-3-1, CORNING, NY, 14831, US

(21) Appl. No.: 12/427,945

(22) Filed: Apr. 22, 2009

(51) Int. Cl. H01S 3/10; G01B 11/00

(52) U.S. Cl. 372/22; 356/399

(57) ABSTRACT

A method for aligning an optical package including a semiconductor laser operable to emit an output beam having a first wavelength, a wavelength conversion device operable to convert the output beam to a second wavelength and adaptive optics configured to optically couple the output beam into a waveguide portion of an input facet of the wavelength conversion device includes measuring a power of light having a first wavelength emitted by or scattered from the wavelength conversion device as the output beam is scanned over the input facet of the wavelength conversion device along a first scanning axis. A power of light emitted from the wavelength conversion device is then measured as the output beam is scanned over the input facet along a second scanning axis. A position of the second scanning axis relative to an edge of the wavelength conversion device is based on the measured power of light having the first wavelength. The output beam is then aligned with the waveguide portion of the input facet based on the measured power of light having the second wavelength.

### BACKGROUND

1. Field

The present invention generally relates to semiconductor lasers, laser controllers, optical packages, and other optical systems incorporating semiconductor lasers. More specifically, the present invention relates to methods for aligning optical packages that include, inter alia, a semiconductor laser optically coupled to a second harmonic generation (SHG) crystal, or another type of wavelength conversion device, with adaptive optics.

2. Technical Background

Short wavelength light sources can be formed by combining a single-wavelength semiconductor laser, such as an infrared or near-infrared distributed feedback (DFB) laser, distributed Bragg reflector (DBR) laser, or Fabry-Perot laser, with a wavelength conversion device, such as a second or higher order harmonic generation crystal. Typically, the wavelength conversion device is used to generate higher harmonic waves of the fundamental laser signal, converting near-infrared light into the visible or ultra-violet portions of the spectrum. To do so, the lasing wavelength of the semiconductor laser is preferably tuned to the spectral center of the wavelength conversion device and the output beam of the laser is preferably aligned with the waveguide portion at the input facet of the wavelength conversion device.

Waveguide optical mode field diameters of typical wavelength conversion devices, such as MgO-doped periodically poled lithium niobate (PPLN) second harmonic generation crystals, may be in the range of a few microns while semiconductor lasers used in conjunction with the wavelength conversion device may comprise a single-mode waveguide having a diameter of approximately the same dimensions. As a result, properly aligning the output beam from the semiconductor laser with the waveguide of the SHG crystal such that the power output of the SHG crystal is optimized may be a difficult task. More specifically, positioning the semiconductor laser such that the output beam is incident on the waveguide portion of the wavelength conversion device may be difficult given the dimension of both the semiconductor laser output beam and the SHG crystal waveguide.

Accordingly, methods for aligning the semiconductor laser optically coupled to a wavelength conversion device, such as a second harmonic generation (SHG) crystal, are needed.

### SUMMARY

A method is disclosed for aligning an optical package including a semiconductor laser operable to emit an output beam with a first wavelength, for example an infrared wavelength, a wavelength conversion device operable to convert the output beam to a second wavelength, for example a visible wavelength, adaptive optics configured to optically couple the output beam into a waveguide portion of an input facet of the wavelength conversion device and a package controller programmed to operate at least one adjustable optical component of the adaptive optics. The alignment method may include determining an edge of the wavelength conversion device by measuring a power of light having the first wavelength emitted from or scattered by a bulk crystal portion of the wavelength conversion device as the output beam of the semiconductor laser is scanned over the input facet of the wavelength conversion device along a first scanning axis. Thereafter, the output beam of the semiconductor laser is positioned on the input facet of the wavelength conversion device such that the output beam of the semiconductor laser is located on a second scanning axis relative to the edge of the wavelength conversion device. The second scanning axis traverses at least a portion of the waveguide portion of the wavelength conversion device. A location of the waveguide portion along the second scanning axis is determined by measuring a power of light emitted from the wavelength conversion device as the output beam of the semiconductor laser is scanned over the input facet of the wavelength conversion device along the second scanning axis. The output beam of the infrared semiconductor laser is then aligned with the waveguide portion of the wavelength conversion device based on the power of light measured as the output beam of the semiconductor laser is scanned along the second scanning axis.

In another embodiment, an optical package may include a semiconductor laser operable to emit an output beam with a first wavelength, a wavelength conversion device operable to convert the output beam to a second wavelength, adaptive optics configured to optically couple the output beam into a waveguide portion of an input facet of the wavelength conversion device, at least one optical detector for measuring a power of light emitted from or scattered by the wavelength conversion device and a package controller. The package controller may be programmed to scan the output beam of the semiconductor laser over the input facet of the wavelength conversion device along a first scanning axis and determine an edge of the wavelength conversion device by measuring a power of light having the first wavelength emitted from or scattered by a bulk crystal portion of the wavelength conversion device as the output beam of the semiconductor laser is scanned over the input facet of the wavelength conversion device along the first scanning axis. Thereafter, the package controller may position the output beam of the semiconductor laser on the input facet of the wavelength conversion device such that the output beam of the semiconductor laser is located on a second scanning axis relative to the edge of the wavelength conversion device. The second scanning axis traverses at least a portion of the waveguide portion of the wavelength conversion device. The package controller may be programmed to then scan the output beam of the semiconductor laser over the input facet of the wavelength conversion device along the second scanning axis and determine a location of the waveguide portion along the second scanning axis by measuring a power of light emitted from the wavelength conversion device as the output beam of the semiconductor laser is scanned over the input facet of the wavelength conversion device along the second scanning axis, wherein the light emitted from the wavelength device as the output beam of the semiconductor laser is scanned along the second scanning axis comprises the first wavelength, the second wavelength, or both. Finally, the package controller is programmed to align the output beam of the semiconductor laser with the waveguide portion of the wavelength conversion device based on the power of light measured as the output beam of the semiconductor laser is scanned along the second scanning axis.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagram of an optical package having a substantially linear configuration according to one embodiment shown and described herein;

FIG. 2 is a schematic diagram of an optical package having a folded configuration according to one embodiment shown and described herein;

FIG. 3A depicts a cross section of a wavelength conversion device according to one or more embodiments shown and described herein;

FIG. 3B depicts a cross section of the wavelength conversion device depicted in FIG. 3A according to one or more embodiments shown and described herein;

FIG. 4A depicts a cross section of a wavelength conversion device according to one or more embodiments shown and described herein;

FIG. 4B depicts a cross section of the wavelength conversion device depicted in FIG. 4A;

FIG. 5A depicts an output beam of a semiconductor laser being scanned over an input facet of a wavelength conversion device according to one embodiment shown and described herein;

FIG. 5B depicts the change in the measured visible and infrared output intensity of the wavelength conversion device as the output beam of the semiconductor laser is scanned over the input facet of the wavelength conversion device in the y-direction, as depicted in FIG. 5A;

FIG. 5C depicts the change in the measured visible and infrared output intensity of the wavelength conversion device as the output beam of the semiconductor laser is scanned over the input facet of the wavelength conversion device in the x-direction, as depicted in FIG. 5A; and

FIG. 6 depicts the change in intensity of scattered infrared light as the output beam of the semiconductor laser is scanned over the input facet of the wavelength conversion device in the y-direction, as depicted in FIG. 5A.

### DETAILED DESCRIPTION OF THE PREFERRED EMBODIMENTS

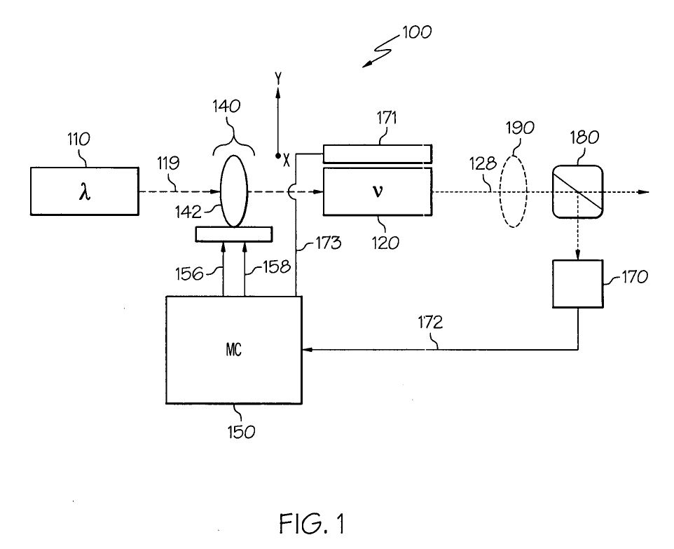

Reference will now be made in detail to embodiments of the invention, examples of which are illustrated in the accompanying drawings. Whenever possible, the same reference numerals will be used throughout the drawings to refer to the same or like parts. One embodiment of an optical package for use in conjunction with the control methods described herein is shown in FIG. 1. The optical package generally comprises a semiconductor laser, adaptive optics, a wavelength conversion device and a package controller. The output of the semiconductor laser may be optically coupled into the input facet of the wavelength conversion device with the adaptive optics. The package controller may be electrically coupled to the adaptive optics and configured to control the alignment of the semiconductor laser with the wavelength conversion device. Various components and configurations of the optical package and methods for aligning the semiconductor laser with the wavelength conversion device will be further described herein.

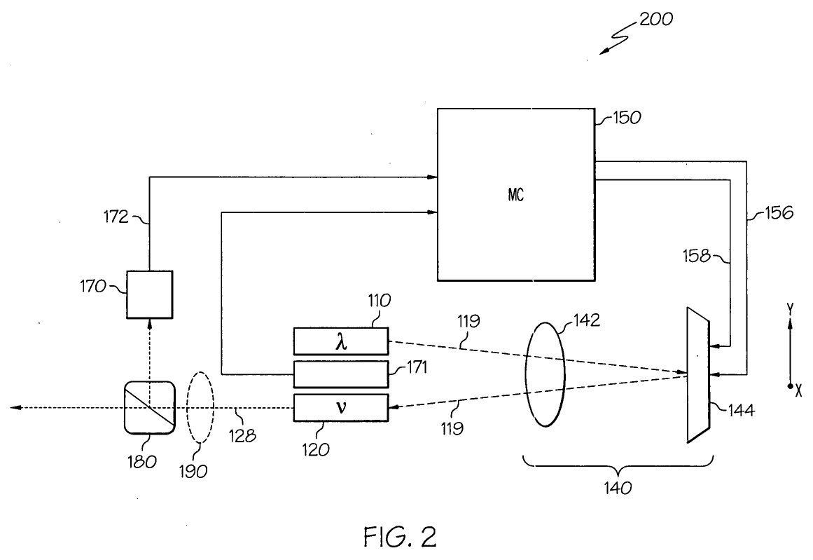

FIGS. 1 and 2 generally depict two embodiments of an optical package 100, 200. It should be understood that the solid lines and arrows indicate the electrical interconnectivity of various components of the optical packages. These solid lines and arrows are also indicative of electrical signals propagated between the various components including, without limitation, electronic control signals, data signals and the like. Further, it should also be understood that the dashed lines and arrows indicate light or light beams emitted by the semiconductor laser and/or the wavelength conversion device while the length of the dashes is indicative of light or light beams having one or more components of differing wavelengths. It should be understood that the term “light” and the phrase “light beam,” as used herein, refer to various wavelengths of electromagnetic radiation emitted from the semiconductor laser and/or the wavelength conversion device and that such light or light beams may have wavelengths corresponding to the ultra-violet, visible or infrared portions of the electromagnetic spectrum.

Referring initially to FIGS. 1 and 2, although the general structure of the various types of optical packages in which the concepts of particular embodiments of the present invention can be incorporated are taught in readily available technical literature relating to the design and fabrication of frequency or wavelength-converted semiconductor laser sources, the concepts of particular embodiments of the present invention may be conveniently illustrated with general reference to the optical packages 100, 200 which include, for example, a semiconductor laser 110 (“λ” in FIGS. 1 and 2) optically coupled to a wavelength conversion device 120 (“ν” in FIGS. 1 and 2). The semiconductor laser 110 may emit an output beam 119 or fundamental beam having a first wavelength λ₁. The output beam 119 of the semiconductor laser 110 may be either directly coupled into the waveguide portion of the wavelength conversion device 120 (not shown) or can be coupled into the waveguide portion of wavelength conversion device 120 using adaptive optics 140, as depicted in FIGS. 1 and 2. The wavelength conversion device 120 converts the output beam 119 of the semiconductor laser 110 into higher harmonic waves and emits an output beam 128 which may comprise light having the first wavelength λ₁ and light having the second wavelength λ₂. This type of optical package is particularly useful in generating shorter wavelength laser beams (e.g., laser beams having a wavelength in the visible spectrum) from longer wavelength semiconductor lasers (e.g. lasers having an output beam having a wavelength in the infrared spectrum). Such devices can be used, for example, as a visible laser source for laser projection systems.

In the embodiments described herein, the semiconductor laser 110 is a laser diode operable to produce an infrared output beam and the wavelength conversion device 120 is operable to convert the output beam of the wavelength conversion device to light having a wavelength in the visible spectrum. However, it should be understood that the optical packages and methods for aligning optical packages described herein may be applicable to other optical packages which incorporate laser devices having different output wavelengths and wavelength conversion devices operable to convert an output beam of a laser into different visible and ultraviolet wavelengths.

Still referring to FIGS. 1 and 2, the wavelength conversion device 120 generally comprises a non-linear optical bulk crystal material 122, such as a second harmonic generation (SHG) crystal. For example, in one embodiment, the wavelength conversion device 120 may comprise an MgO-doped, periodically polled lithium niobate (PPLN) crystal. However, it should be understood that other, similar non-linear optical crystals may be used. Further, it should be understood that the wavelength conversion device may be a second harmonic generation (SHG) crystal or a non-linear optical crystal capable of converting light to higher order (e.g., 3^{rd}, 4^{th}, etc.) harmonics.

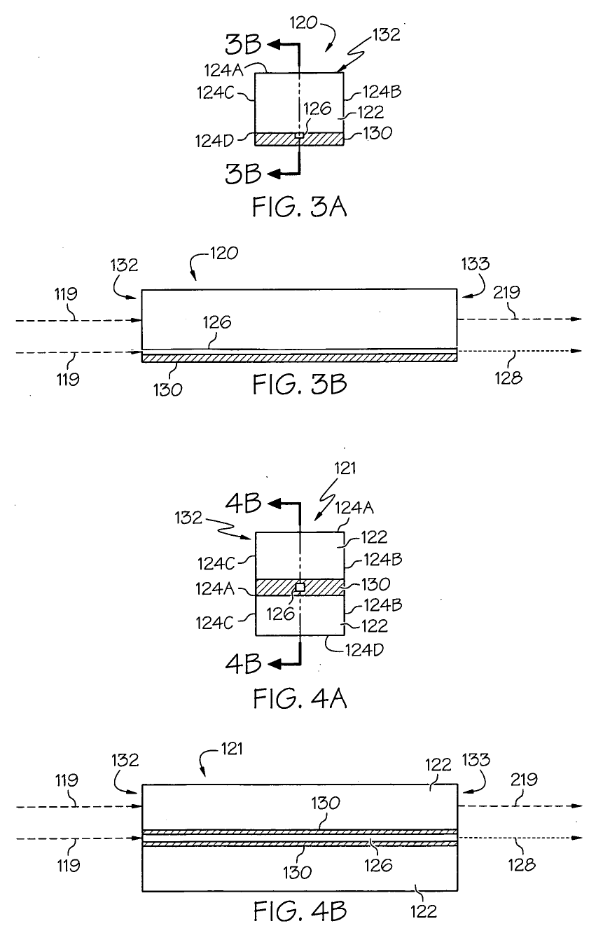

Referring now to FIGS. 3A-4B, two embodiments of a wavelength conversion device 120, 121 are shown. In both embodiments the wavelength conversion device 120, 121 comprises a bulk crystal material 122, such as lithium niobate, with an embedded waveguide portion 126, such as MgO-doped lithium niobate, which extends between an input facet 132 and an output facet 133. When the wavelength conversion device 120 is a PPLN crystal, the waveguide portion 126 of the PPLN crystal may have dimensions (e.g., height and width) on the order of 5 microns.

Referring to the embodiment shown in FIGS. 3A and 3B, the wavelength conversion device 120 may be substantially rectangular or square in cross section. As shown in FIG. 3A, the input facet 132 may be defined by a top edge 124A, side edges 124B and 124C, and a bottom edge 124D. The waveguide portion 126 is disposed adjacent the bottom edge 124D of the bulk crystal material 122 and is embedded in a low refractive index layer 130. Typical cross sectional dimensions of the bulk crystal 122 are on the order of 500-1500 microns, whereas the low index layer 130 is typically a few microns to tens of microns in thickness.

In the embodiment of the wavelength conversion device 121 shown in FIGS. 4A and 4B, the wavelength conversion device 121 comprises a waveguide portion 126 which is embedded in a low refractive index layer 130 which is disposed between two slabs of bulk crystal material 122A, 122B. The waveguide portion 126 extends between an input face 132 and an output facet 133 of the wavelength conversion device 121. Referring to FIG. 4A, each slab of bulk crystal material 122A, 122B may be substantially rectangular or square in cross section and comprise a top edge 124A, side edges 124B and 124C, and a bottom edge 124D.

Referring to FIGS. 3B and 4B, when a light beam having a first wavelength λ₁ is directed into the waveguide portion 126 of the wavelength conversion device 120, such as the output beam 119 of the semiconductor laser 110, the light beam may be propagated along the waveguide portion 126 of the wavelength conversion device 120 where at least a portion of the light beam is converted to a second wavelength λ₂. The wavelength conversion device 120 emits a light beam 128 from the output facet 133. The light beam 128 may comprise converted wavelength light (e.g., light having a second wavelength λ₂) as well as unconverted light (e.g., light having the first wavelength λ₁). For example, in one embodiment, the output beam 119 produced by the semiconductor laser 110 and directed into the waveguide portion 126 of the wavelength conversion device 120 has a wavelength of about 1060 nm (e.g., the output beam 119 is an infrared light beam). In this embodiment, the wavelength conversion device 120 converts at least a portion of the infrared light beam to visible light such that the waveguide portion 126 of the wavelength conversion device emits a light beam 128 comprising light at a wavelength of about 530 nm (e.g., visible green light) in addition to light having a wavelength of about 1060 nm.

In another embodiment, when a light beam having a first wavelength λ₁, such as the output beam 119 of the semiconductor laser 110, is directed onto the input facet 132 of the wavelength conversion device, but not into the waveguide portion 126 of the wavelength conversion device 120 (e.g., the light beam is incident on the bulk crystal material 122 of the wavelength conversion device 120), due to the phenomenon of total internal reflection, the light beam is guided through the bulk crystal material 122 of the wavelength conversion device 120 and emitted from the output facet 133 without being converted to a second wavelength λ₂. For example, when the output beam 119 incident on the non-waveguide portion or bulk crystal material 122 of the wavelength conversion device 120 has a first wavelength λ₁ of 1060 nm (e.g., the output beam 119 is an infrared beam), the light beam 219 emitted from the output facet 133 of the wavelength conversion device will also have a wavelength of 1060 nm as little or no wavelength conversion occurs in the bulk crystal material 122.

Referring again to FIGS. 1 and 2, two embodiments of optical packages 100, 200 are shown which utilize a wavelength conversion device and a semiconductor laser. In one embodiment, the optical package 100 is depicted in which the semiconductor laser 110 and the wavelength conversion device 120 have a substantially linear configuration, as shown in FIG. 1. More specifically, the output of the semiconductor laser 110 and the input of the wavelength conversion device 120 are substantially aligned along a single optical axis. As shown in FIG. 1, the output beam 119 emitted by the semiconductor laser 110 is coupled into a waveguide portion of the wavelength conversion device 120 with adaptive optics 140.

In the embodiment shown in FIG. 1, the adaptive optics 140 generally comprise an adjustable optical component, specifically a lens 142. The lens 142 collimates and focuses the output beam 119 emitted by the semiconductor laser 110 into the waveguide portion of the wavelength conversion device 120. However, it should be understood that other types of lenses, multiple lenses, or other optical elements may be used. The lens 142 may be coupled to an actuator (not shown) for adjusting the position of the lens 142 in the x- and y-directions such that the lens 142 is an adjustable optical component. Adjusting the position of the lens in the x- and y-directions may facilitate positioning the output beam 119 along the input facet of the wavelength conversion device 120 such that the output beam 119 is aligned with the waveguide portion and the output of the wavelength conversion device 120 is optimized. In the embodiments described herein, the actuator may comprise a MEMS device, a piezo-electric device, voice coils, or similar mechanical or electro-mechanical actuators operable to impart translational motion to the lens in the x- and y-directions.

Referring now to FIG. 2, another embodiment of an optical package 200 is shown in which the semiconductor laser 110, the wavelength conversion device 120 and the adaptive optics 140 are oriented in a folded configuration. More specifically, the output beam 119 of the semiconductor laser 110 and the input facet of the wavelength conversion device 120 are positioned on substantially parallel optical axes. As with the embodiment shown in FIG. 1, the output beam 119 emitted by the semiconductor laser 110 is coupled into the waveguide portion of the wavelength conversion device 120 with adaptive optics 140. However, in this embodiment, the output beam 119 must be redirected from its initial pathway to facilitate coupling the output beam 119 into the waveguide portion of the wavelength conversion device 120. Accordingly, in this embodiment, the adaptive optics 140 may comprise an adjustable optical component, specifically an adjustable mirror 144, and a lens 142.

As described hereinabove, the lens 142 of the adaptive optics 140 may collimate and focus the output beam 119 emitted by the semiconductor laser 110 into the waveguide portion of the wavelength conversion device 120 while the adjustable mirror 144 redirects the output beam 119 from a first pathway to a second pathway. Specifically, the adjustable mirror 144 may be rotated about an axis of rotation substantially parallel to the x-axis and y-axis depicted in FIG. 2 to introduce angular deviation in the output beam 119. The adjustable mirror 144 may comprise a mirror portion and an actuator portion. The adjustable mirror 144 may be rotated about either axis of rotation by adjusting the actuator portion of the adjustable optical component. In the embodiments described herein, the actuator portion of the adjustable optical component may comprise a MEMS device, a piezo-electric device, voice coils, or similar actuators operable to provide rotational motion to the mirror portion.

For example, in one embodiment, the adjustable mirror 144 may comprise one or more movable micro-opto-electromechanical systems (MOEMS) or micro-electro-mechanical system (MEMS) operatively coupled to a mirror. The MEMS or MOEMS devices may be configured and arranged to vary the position of the output beam 119 on the input facet of the wavelength conversion device 120. Use of MEMS or MOEMS devices enables adjustment of the output beam 119 to be done extremely rapidly over large ranges. For example, a MEMS mirror with a ±1 degree mechanical deflection, when used in conjunction with a 3 mm focal length lens, may allow the beam spot of the output beam 119 to be angularly displaced ±100 μm on the input facet 132 of the wavelength conversion device 120. The adjustment of the beam spot may be done at frequencies on the order of 100 Hz to 10 kHz due to the fast response time of the MEMS or MOEMS device.

Alternatively or additionally, the adjustable optical component may comprise one or more liquid lens components configured for beam steering and/or beam focusing. Still further, it is contemplated that the adjustable optical component may comprise one or more mirrors and/or lenses mounted to micro-actuators. In one contemplated embodiment, the adjustable optical component may be a movable or adjustable lens, as described with respect to FIG. 1, used in conjunction with a fixed mirror to form a folded optical pathway between the semiconductor laser 110 and the wavelength conversion device 120.

In the optical package 200 illustrated in FIG. 2, the adjustable mirror 144 is a micro-opto-electromechanical mirror incorporated in a relatively compact, folded-path optical system. In the illustrated configuration, the adjustable mirror 144 is configured to fold the optical path such that the optical path initially passes through the lens 142 to reach the adjustable mirror 144 as a collimated or nearly collimated beam and subsequently returns through the same lens 142 to be focused on the wavelength conversion device 120. This type of optical configuration is particularly applicable to wavelength converted laser sources where the cross-sectional size of the output beam generated by the semiconductor laser 110 is close to the size of the waveguide on the input facet of the wavelength conversion device 120, in which case a magnification close to one would yield optimum coupling in focusing the beam spot on the input face of the wavelength conversion device 120. For purposes of defining and describing this embodiment of the optical package 200, it is noted that reference herein to a “collimated or nearly collimated” beam is intended to cover any beam configuration where the degree of beam divergence or convergence is reduced, directing the beam towards a more collimated state.

While the embodiments of the optical packages 100, 200 shown in FIGS. 1 and 2 depict the output beam 119 of the semiconductor laser 110 being coupled into the wavelength conversion device 120 with adaptive optics 140, it should be understood that optical packages having other configurations are possible. For example, in another embodiment (not shown) the wavelength conversion device 120 may be mechanically coupled to an actuator, such as a MEMS device, piezo-electric device or the like, which facilitates moving the wavelength conversion device 120 relative to the output beam 119 of the semiconductor laser 110. Using such an actuator, the wavelength conversion device may be positioned to align the waveguide portion of the wavelength conversion device with the output beam 119 using the techniques further described herein.

Referring now to both FIGS. 1 and 2, the optical packages 100, 200 may also comprise an optical detector 170, such as a photodiode, a collimating lens 190, and a beam splitter 180. The beam splitter 180 and collimating lens 190 are positioned proximate the output facet 133 of the wavelength conversion device 120. The collimating lens 190 focuses light emitted from the output facet 133 into the beam splitter 180 which redirects a portion of the light beam 128 emitted from the output facet 133 of the wavelength conversion device 120 into an optical detector 170. The optical detector 170 is operable to measure the power of light emitted from the output facet 133 of the wavelength conversion device 120. For example, in one embodiment, when the output beam 119 of the semiconductor laser is infrared light, the optical detector 170 is operable to measure the intensity or power of the infrared light emitted from the output facet 133.

Still referring to FIGS. 1 and 2, in one embodiment, the optical packages 100, 200 may additionally comprise a second optical detector 171. The second optical detector 171 may be positioned adjacent to a side of the wavelength conversion device 120 and oriented such that the optical detector is substantially parallel to the optical axis of the wavelength conversion device 120 (e.g., an axis extending between the output facet and the input facet). In one embodiment (not shown), the second optical detector 171 is attached adjacent to or on the top or side of the wavelength conversion device. The second optical detector 171 is operable to measure light of the output beam 119 which is scattered from wavelength conversion device 120 (e.g., from the bulk crystal material 122 and/or the low refractive index layer 130) or other components of the optical packages 100, 200. For example, in one embodiment, when the output beam 119 of the semiconductor laser is infrared light, the second optical detector 171 may be operable to measure the intensity or power of the infrared light scattered by the wavelength conversion device 120.

In yet another embodiment (not shown), the beam splitter 180 shown in FIGS. 1 and 2 is a dichroic beam splitter and the second optical detector is positioned relative to the beam splitter such that light emitted from the wavelength conversion device having a first wavelength λ₁ is directed into the optical detector 170 while light emitted from the wavelength conversion device having a second wavelength λ₂ is directed into the second optical detector 171. In this embodiment, the optical detectors 170, 171 are operable to measure light having a first wavelength λ₁ and light having a second wavelength λ₂, respectively. For example, when the output beam 119 is an infrared beam and the wavelength conversion device is operable to convert the infrared beam to visible light, the optical detector 170 may be operable to measure the power of infrared light emitted from the output facet 133 while the second optical detector 171 may be operable to measure the power of visible light emitted from the output facet 133.

The optical packages 100, 200 may also comprise a package controller 150 (“MC” in FIGS. 1 and 2). The package controller 150 may comprise one or more micro-controllers or programmable logic controllers used to store and execute a programmed instruction set for operating the optical package 100, 200. Alternatively, the micro-controllers or programmable logic controllers may directly execute an instruction set. The package controller 150 may be electrically coupled to the semiconductor laser 110, the adaptive optics 140 and the optical detectors 170, 171 and programmed to operate the adaptive optics 140 and receive signals from the optical detectors 170, 171.

Referring to FIGS. 1 and 2, the package controller 150 may be coupled to the adaptive optics 140 with leads 156, 158 and supply the adaptive optics 140 with x- and y-position control signals through the leads 152, 158, respectively. The x- and y-position control signals facilitate positioning the adjustable optical component of the adaptive optics in the x- and y-directions which, in turn, facilitates positioning the output beam 119 of the semiconductor laser 110 in the x- and y-directions on the input facet of the wavelength conversion device 120. For example, when the adjustable optical component of the adaptive optics 140 is an adjustable lens 142, as shown in FIG. 1, the x- and y-position control signals may be used to position the lens 142 in the x- and y-directions. Alternatively, when the adjustable optical component of the adaptive optics 140 is an adjustable mirror 144, as shown in FIG. 2, the x-position control signal may be used to rotate the adjustable mirror 144 about an axis of rotation parallel to the y-axis such that a light beam reflected from the mirror is scanned in the x-direction. Similarly, the y-position control signal may be used to rotate the adjustable mirror 144 about an axis of rotation parallel to the x-axis such that a light beam reflected from the mirror is scanned in the y-direction.

Further, the output of the optical detectors 170, 171 may be electrically coupled to the package controller 150 with leads 172, 173, respectively, such that the output signals of the optical detectors 170, 171, which are indicative of a power of light measured by the detectors, are passed to the package controller 150 for use in controlling the adaptive optics.

Methods for aligning the semiconductor laser with the waveguide portion of the wavelength conversion device of the optical packages 100, 200 will now be discussed with reference to the optical packages 100, 200 shown in FIGS. 1 and 2 and the wavelength conversion device 120 depicted in FIG. 3. However is should be understood that the methods described herein may also be applied to wavelength conversion devices as depicted in FIG. 4.

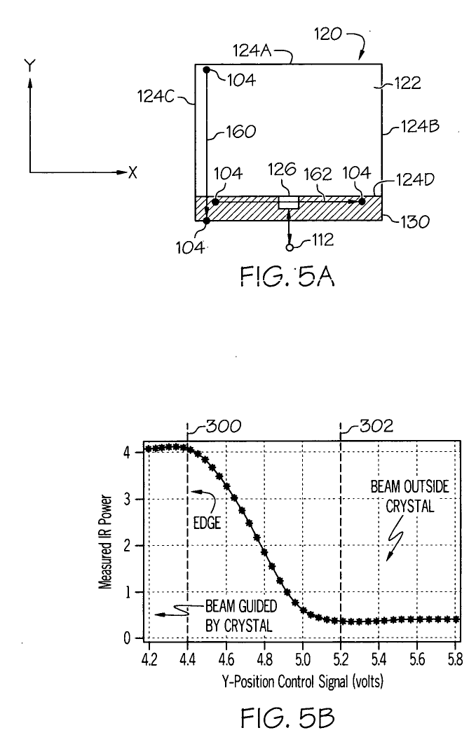

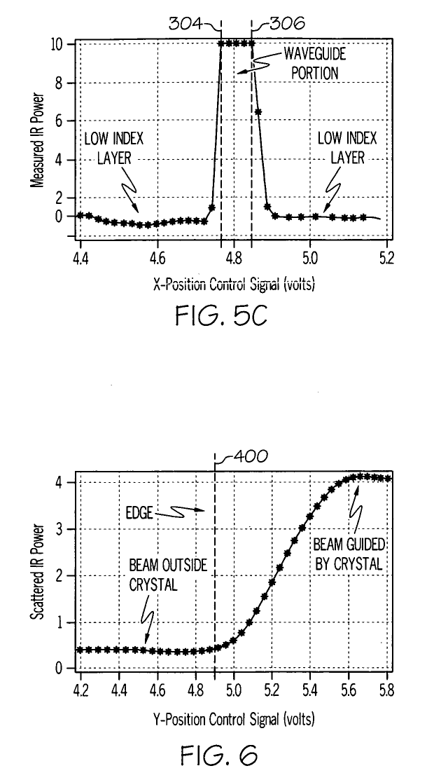

Referring now to FIGS. 1, 2, 5A-5B and 6, one embodiment of the method of aligning the output beam of the semiconductor laser with the waveguide portion 126 of wavelength conversion device 120 is schematically illustrated. The method includes directing the output beam 119 of the semiconductor laser 110 onto the input facet 132 of the wavelength conversion device 120. The output beam 119, which is also referred to herein as a beam spot 104, such as the beam spot 104 depicted in FIG. 5A, is initially directed onto the input facet 132 such that the beam spot 104 is incident on the bulk crystal material 122 of the wavelength conversion device 120. In one embodiment, the package controller 150 may be programmed to adjust the adaptive optics 140 such that the output beam 119 is positioned on the bulk crystal material 122 of the wavelength conversion device 120.

In one embodiment, where the optical package has a folded configuration, as shown in FIG. 2, the input facet 132 of the wavelength conversion device 120 and the output waveguide 112 of the semiconductor laser 110 may be positioned in the same plane or in parallel planes with the output waveguide 112 typically located directly below the waveguide portion 126 of the wavelength conversion device 120. In an optical package having this configuration it may be possible to inadvertently reflect the output beam 119 into the output waveguide 112 of the semiconductor laser 110, which, in turn, may damage the semiconductor laser 110. In this embodiment, in order to avoid damaging the semiconductor laser 110, the package controller 150 may be programmed to initially position the output beam 119 on the input facet 132 of the wavelength conversion device such that the beam spot 104 is positioned proximate an edge (e.g. edge 124B or edge 124C) of the input facet 132. For example, in one embodiment, where the adjustable mirror 144 is a MEMS-actuated mirror, the package controller 150 may be programmed to adjust the position of the MEMS-actuated mirror about the y-axis such that the beam spot 104 is located on the input facet 132 proximate edge 124C of the wavelength conversion device 120, as depicted in FIG. 5A. With the beam spot 104 initially located in this position, the output beam 119 of the semiconductor laser 110 cannot be reflected into the output waveguide 112 of the semiconductor laser 110 during a scan of the output beam 119 in the y-direction.

Once the output beam 119 is positioned on the input facet 132 of the wavelength conversion device 120, the output beam 119 is scanned along a first scanning axis 160. In the embodiment shown, the first scanning axis 160 is parallel to the y-axis. The package controller 150 may be programmed to scan the output beam 119 over the input facet 132 by adjusting the position control signals sent to the adjustable optical component and thereby adjusting the position of the adjustable optical component and, in turn, the position of the beam spot 104 on the input facet 132. For example, the package controller 150 may be programmed to scan the beam spot 104 over the input facet 132 along the first scanning axis 160 by sending a y-position control signals to the adjustable optical component thereby positioning the adjustable optical component such that the output beam 119 and beam spot 104 are scanned in the y-direction.

In one embodiment, as the output beam 119 is scanned along the first scanning axis 160, the power of light emitted from the bulk crystal material 122 of the wavelength conversion device 120 is monitored with the optical detector 170. For example, when the output beam 119 of the semiconductor laser 110 has a first wavelength λ₁ in the infrared range, the power of the infrared light emitted from the bulk crystal material 122 of the wavelength conversion device is measured with the optical detector 170 and transmitted to the package controller 150. A plot of the measured power of IR light emitted from the bulk crystal material as a function of the y-position control signal supplied to the adjustable optical component during scanning is shown in FIG. 5B.

Referring now to FIGS. 5A and 5B, as the output beam 119 is scanned along the first scanning axis 160, the output beam transitions from the bulk crystal material 122 to the low refractive index layer 130 and out of the wavelength conversion device 130 entirely. The transition from the bulk crystal material 122 is accompanied by a corresponding decrease in the power of the light emitted by the wavelength conversion device 120. For example, referring to FIG. 5B, in one embodiment, the transition of the output beam 119 from the bulk crystal material 122 to the low refractive index layer generally occurs when the y-position control signal of the adjustable optical component has a value of about 4.4 volts, as indicated by vertical line 300. As the scan continues along the first scanning axis, the output power of the wavelength conversion device 120 continues to decrease until no portion of the output beam 119 is located on the bulk crystal material 122 at which point the output power of the wavelength conversion device 120 is reduced to a lesser amount. This point is indicated in FIG. 5B by vertical line 302 which generally corresponds to a y-position control signal of 5.2 volts applied in the illustrated example. The transition between a large amount of detected light and a low amount of detected light, as shown in FIG. 5B, is representative of when the beam crosses the lower edge of the wavelength conversion device and is thus indicative of the edge of the wavelength conversion device. The power received by the detector is greater when the light is guided through the bulk crystal material by total internal reflection and the power is less when the beam is outside of the bulk crystal material and is not guided to the detector. The package controller 150 may be programmed to identify the y-position control signal applied to the adjustable optical component when this transition is reached and store this y-position control signal for use in determining the second scanning axis and positioning the beam spot 104 on the second scanning axis.

It should be understood that, while FIGS. 5A and 5B show an output beam of a semiconductor laser scanned over the input facet of a wavelength conversion device 120 having a configuration similar to that shown in FIGS. 3A and 3B in order to locate an external edge of the crystal (e.g., bottom edge 124D), the wavelength conversion device may have a configuration similar to the wavelength conversion device 121 shown in FIGS. 4A and 4B. With a wavelength conversion device having a configuration as depicted in FIGS. 4A and 4B, the scan of the output beam of the semiconductor laser over the input facet of the wavelength conversion device may be used to locate an internal edge or interface between the two slabs of bulk crystal material 122A, 122B. For example, the scan may be used to determine the transition from the bottom edge 124D of the bulk crystal material 122A to the upper edge 124A of the bulk crystal material 122B.

In another embodiment, as the output beam 119 is scanned along the first scanning axis 160, the power of light scattered from the bulk crystal material 122 and low refractive index layer 130 of the wavelength conversion device 120 is measured with the second optical detector. In this embodiment, the second optical detector 171 is positioned substantially parallel to the optical axis of the wavelength conversion device (e.g., an axis extending between the input facet 132 and the output facet 133), as depicted in FIGS. 1 and 2. This detector is operable to measure the power of light scattered out of either the bulk crystal material 122 and/or the low refractive index layer 130. A plot of IR light scattered from the wavelength conversion device 120 is shown in FIG. 6 as a function of the y-position control signal applied to the adjustable optical component.

Referring to FIGS. 5A and 6, as the package controller 150 scans the output beam 119 and beam spot 104 over the input facet 132, the beam spot 104 is initially incident on the bulk crystal material 122 and the output beam 119 is transmitted through the bulk crystal material. Accordingly, when the beam spot 104 is incident on and guided by the bulk crystal material 122 very little light is scattered to the detector 171, as shown in FIG. 6. However, as the beam spot 104 transitions out of the bulk crystal material 122, the IR light of the output beam 119 is scattered by elements of the optical package. This scattered light is detected by the second optical detector 171, as shown in FIG. 6, and the package controller 150 correlates the increase in the power of the scattered light to a specific control signal applied to the adjustable optical component. In the example shown in FIG. 6, the transition from the bulk crystal material 122 to outside the bulk crystal material is indicated by line 400, which, in turn, represents the bottom edge 124D of the crystal. The y-position control signal corresponding to the line 400 (approximately 4.9 volts in the illustrated example) corresponds to a position of the adjustable optical component where the output beam is positioned below the edge 124D of the crystal. This y-position control signal may be stored for use in determining the second scanning axis and positioning the beam spot on the second scanning axis. Hence, in terms of detected infrared light, the side mounted detector 171 observes a signal which is roughly an inverse of what the output mounted detector 170 observes.

After the y-position control signal corresponding to the bottom edge 124D of the wavelength conversion device is determined, the package controller 150 may determine a second scanning axis 162 which extends across the waveguide portion 126 of the wavelength conversion device. The determination of the location of the second scanning axis is based upon the known distance between the waveguide portion 126 and the bottom edge 124D of the wavelength conversion device 120. Using this known distance and the y-position control signal corresponding to the bottom edge 124D, the package controller determines a y-position control signal to position the output beam 119 on the input facet 132 such that, when the beam is scanned in the x-direction (e.g., the second scanning axis 162) the output beam 119 traverses across the waveguide portion 126. Accordingly, this determined y-position control signal corresponds to the position of the second scanning axis 162. In the example illustrated in FIG. 5A the second scanning axis 162 is generally parallel to the x-axis.

Once the position of the second scanning axis 162 is determined, the package controller 150 applies a y-position control signal to the adjustable optical component to position the adjustable optical component such that the beam spot 104 of the output beam 119 is located on the second scanning axis 162. Thereafter, the package controller 150 adjusts the x-position control signal applied to the adjustable optical component to scan the output beam 119 along the second scanning axis 162. In one embodiment, as the output beam is scanned over the second scanning axis 162, the package controller 150 may modulate the y-position control signal applied to the adjustable optical component such that beam spot 104 is dithered in the y-direction thereby increasing the effective area covered by the scan along the second scanning axis.

As the output beam 119 is scanned along the second scanning axis 162, the power of light emitted from the output facet 133 of the wavelength conversion device 120 and having the same wavelength as the fundamental beam (e.g., λ₁) is monitored with the optical detector 170. For example, as described above, when the output beam 119 of the semiconductor laser 110 has a first wavelength λ₁ in the infrared range, the power of the infrared light emitted from the bulk crystal material 122 is measured with the optical detector 170, which, in turn, relays an electrical signal to the package controller 150 indicative of the measured power of the emitted light.

Referring to FIG. 5C, which shows a plot of measured IR power emitted from the output facet 133 as a function of the voltage applied to the adjustable optical component, the position of the waveguide portion of the wavelength conversion device and, more specifically, a position of the adjustable optical component where the beam spot 104 is aligned with the waveguide portion 126, may be determined based on the change in the power of the light emitted from the wavelength conversion device 120. For example, referring to FIGS. 5A and 5C, as the beam spot is scanned along the second scanning axis along the low refractive index layer 130, the measured output of the wavelength conversion device is low as most of the optical power of the semiconductor laser is not guided effectively to the detector 170. However, as the beam transitions onto the waveguide portion 126, the output power spikes as the output beam 119 is effectively and efficiently guided through the waveguide portion 126 and emitted at the output facet of the wavelength conversion device 120. Accordingly, this increase in the optical power output, which is indicated in FIG. 5C by lines 304 and 306, generally corresponds to a position of the adjustable optical component where the output beam 119 is aligned with the waveguide portion 126. The package controller 150 may be programmed to identify this increase in power and correlate the increase to a corresponding x-position control signal which may be applied to the adjustable optical component to drive the adjustable optical component to a position of alignment with the waveguide portion of the wavelength conversion device. In the example illustrated in FIG. 5C, the x-position control signal which yields alignment is about 4.8 volts. The identified x-position control signal is then stored in a memory associated with the package controller 150 and subsequently used in conjunction with the previously determined y-position control signal to align the semiconductor laser with the wavelength conversion device.

It should now be understood that, by monitoring the position of the adjustable optical component and the output power of the wavelength conversion device as the output beam is scanned along the second scanning axis 162, a position of the adjustable optical component may be determined such that the output beam 119 is aligned with the waveguide portion 126 of the wavelength conversion device 120. The package controller 150 may then position the adjustable optical component such that output beam 119 of the semiconductor laser 110 is aligned with the waveguide portion 126 based on the measured output power of the wavelength conversion device 120 along the first scanning axis and the second scanning axis.

While the embodiments described herein show the output beam of the semiconductor laser being aligned with the wavelength conversion device using adaptive optics, it should be understood that other methods may be used. In one embodiment, the methods described herein may be used to align the optical package during assembly of the optical package. For example, during assembly of the optical package, the semiconductor laser and/or the adaptive optics (e.g., the lens or lens/MEMS mirror unit) may be coupled to an actuator, such as an x-y stage or similar actuator, which may be operable to position the components in the x- and y-directions and thereby adjust the relative positions of the semiconductor laser, adaptive optics and wavelength conversion device. In this embodiment the components may be aligned according to the method described herein by using the actuator to facilitate scanning the output beam along the first scanning axis and the second scanning axis. Once alignment is reached, the components may be fixed in place and the actuators removed.

The embodiments shown and described herein relate to a method of aligning a semiconductor laser with a wavelength conversion device based on the power of unconverted light emitted from the wavelength conversion device. For example, when the semiconductor laser emits an output beam having a first wavelength, the output power of the wavelength conversion device is measured at the same wavelength. However, in another embodiment, a second wavelength of light emitted by the wavelength conversion device may be utilized for purposes of alignment. For example, when the wavelength conversion device is a PPLN crystal, as described above, and the semiconductor laser emits an output beam with a wavelength λ₁ directed into the waveguide portion of the wavelength conversion device, a second harmonic beam having a second wavelength λ₂ may be emitted from the output facet of the wavelength conversion device 120. The power of the light emitted at this second wavelength may be measured as the output beam of the wavelength conversion device is scanned along the second scanning axis 162 and changes in the power of the light emitted at the second wavelength may be used by the controller to align the output beam with the waveguide portion of the wavelength conversion device, as described above.

Accordingly, it should now be understood that the alignment methods described herein may be used to rapidly align the output beam of the semiconductor laser with the waveguide portion of the wavelength conversion device. The methods described herein take advantage of the light guiding properties of the bulk crystal to determine when the optical beam strikes the edges of the crystal. This edge detection, along with the knowledge of where the waveguide is located relative to the crystal edges, facilitates rapidly locating the waveguide portion of the wavelength conversion device in 2-dimensional search space. For example, using the methodology described herein, alignment may be obtained by performing two linear scans of the output beam across the input facet of the wavelength conversion device. Further, compared to a raster scan, which would require sampling N² discrete locations along the input facet, the methodologies described herein only require sampling at most 2N discrete locations. Moreover, the number of discrete locations that are sampled may be reduced to less than 2N if the scan along the first scanning axis and the second scanning axis are stopped once the edge of the crystal and the location of the waveguide are determined. Accordingly, the methodologies described herein enable an improved alignment process without sacrificing precision or accuracy.

While examples described herein refer to the use of an infrared fundamental beam and a visible or green second harmonic beam, it should be understood that the methodology may be used in conjunction with other optical systems which incorporate fundamental beams and second harmonic beams having different wavelengths.

It is to be understood that the preceding detailed description of the invention is intended to provide an overview or framework for understanding the nature and character of the invention as it is claimed. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

For the purposes of defining and describing the present invention, it is noted that reference herein to values that are “on the order of” a specified magnitude should be taken to encompass any value that does not vary from the specified magnitude by one or more orders of magnitude. It is also noted that one or more of the following claims recites a controller “programmed to” execute one or more recited acts. For the purposes of defining the present invention, it is noted that this phrase is introduced in the claims as an open-ended transitional phrase and should be interpreted in like manner as the more commonly used open-ended preamble term “comprising.” In addition, it is noted that recitations herein of a component of the present invention, such as a controller being “programmed” to embody a particular property, function in a particular manner, etc., are structural recitations, as opposed to recitations of intended use. More specifically, the references herein to the manner in which a component is “programmed” denotes an existing physical condition of the component and, as such, is to be taken as a definite recitation of the structural characteristics of the component.

It is noted that terms like “preferably,” “commonly,” and “typically,” when utilized herein, are not intended to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Further, it is noted that reference to a value, parameter, or variable being a “function of” another value, parameter, or variable should not be taken to mean that the value, parameter, or variable is a function of one and only one value, parameter, or variable.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation. e.g., “substantially above zero,” varies from a stated reference, e.g., “zero,” and should be interpreted to require that the quantitative representation varies from the stated reference by a readily discernable amount.

What is claimed is:

1. A method for aligning an optical package comprising a semiconductor laser operable to emit an output beam with a first wavelength, a wavelength conversion device operable to convert the output beam to a second wavelength, adaptive optics configured to optically couple the output beam into a waveguide portion of an input facet of the wavelength conversion device, and a package controller programmed to operate at least one adjustable optical component of the adaptive optics, the method comprising:
determining an edge of the wavelength conversion device by measuring a power of light having the first wavelength emitted from or scattered by a bulk crystal portion of the wavelength conversion device as the output beam of the semiconductor laser is scanned over the input facet of the wavelength conversion device along a first scanning axis;
positioning the output beam of the semiconductor laser on the input facet of the wavelength conversion device such that the output beam of the semiconductor laser is located on a second scanning axis relative to the edge of the wavelength conversion device, wherein the second scanning axis traverses at least a portion of the waveguide portion of the wavelength conversion device;
determining a location of the waveguide portion along the second scanning axis by measuring a power of light emitted from the wavelength conversion device as the output beam of the semiconductor laser is scanned over the input facet of the wavelength conversion device along the second scanning axis; and
aligning the output beam of the infrared semiconductor laser with the waveguide portion of the wavelength conversion device based on the power of light measured as the output beam of the semiconductor laser is scanned along the second scanning axis.

2. The method of claim 1 wherein the output beam of the semiconductor laser is infrared light and the wavelength conversion device is a second harmonic generation crystal operable to convert the infrared light to visible light.

3. The method of claim 1 wherein light comprising the first wavelength measured along the first scanning axis is scattered light.

4. The method of claim 3 wherein the power of the light having the first wavelength is measured with an optical detector positioned substantially parallel to an optical axis of the wavelength conversion device.

5. The method of claim 1 wherein light comprising the first wavelength measured along the first scanning axis is emitted from an output facet of the wavelength conversion device.

6. The method of claim 5 wherein light comprising the first wavelength is measured by redirecting the light emitted from the output facet of the wavelength conversion device with a beam splitter into an optical detector.

7. The method of claim 1 wherein light measured as the output beam of the semiconductor laser is scanned over the second scanning axis comprises the first wavelength, the second wavelength, or both.

8. The method of claim 7 wherein the light measured as the output beam of the semiconductor laser is scanned along the second scanning axis comprises light having the first wavelength emitted from the output facet and waveguide portion of the wavelength conversion device.

9. The method of claim 7 wherein the light measured as the output beam of the semiconductor laser is scanned along the second scanning axis comprises light having the second wavelength emitted from the waveguide portion of the wavelength conversion device.

10. The method of claim 1 further comprising modulating a position of the output beam of the semiconductor laser in a direction substantially perpendicular to the second scanning axis as the output beam of the semiconductor laser is scanned along the second scanning axis.

11. The method of claim 1 further comprising positioning the output beam of the semiconductor laser on the input facet of the wavelength conversion device such that the output beam of the semiconductor laser is not reflected into an output waveguide of the semiconductor laser when the output beam of the semiconductor laser is scanned along the first scanning axis and the second scanning axis.

12. The method of claim 1 wherein the output beam of the semiconductor laser is scanned along the first scanning axis and the second scanning axis by adjusting a position of the adjustable optical component.

13. The method of claim 1 wherein the adjustable optical component is an adjustable mirror and the semiconductor laser, wavelength conversion device and adaptive optics are positioned to form a folded optical pathway.

14. The method of claim 13 wherein the adjustable mirror is a MEMS mirror.

15. The method of claim 1 wherein the adjustable optical component is an adjustable lens and the semiconductor laser, wavelength conversion device and adaptive optics are configured to form a substantially linear optical pathway.

16. The method of claim 1 wherein the output beam of the semiconductor laser is scanned along the first scanning axis and the second scanning axis using at least one mechanical actuator to adjust a relative position of the semiconductor laser, adaptive optics and wavelength conversion device.

17. The method of claim 1 wherein the first scanning axis and the second scanning axis are substantially perpendicular to one another.

18. An optical package comprising a semiconductor laser operable to emit an output beam with a first wavelength, a wavelength conversion device operable to convert the output beam to a second wavelength, adaptive optics configured to optically couple the output beam into a waveguide portion of an input facet of the wavelength conversion device, at least one optical detector for measuring a power of light emitted from or scattered by the wavelength conversion device and a package controller, wherein the package controller is programmed to:
scan the output beam of the semiconductor laser over the input facet of the wavelength conversion device along a first scanning axis;
determine an edge of the wavelength conversion device by measuring a power of light having the first wavelength emitted from or scattered by a bulk crystal portion of the wavelength conversion device as the output beam of the semiconductor laser is scanned over the input facet of the wavelength conversion device along the first scanning axis;
position the output beam of the semiconductor laser on the input facet of the wavelength conversion device such that the output beam of the semiconductor laser is located on a second scanning axis relative to the edge of the wavelength conversion device, wherein the second scanning axis traverses at least a portion of the waveguide portion of the wavelength conversion device;
scan the output beam of the semiconductor laser over the input facet of the wavelength conversion device along the second scanning axis;
determine a location of the waveguide portion along the second scanning axis by measuring a power of light emitted from the wavelength conversion device as the output beam of the semiconductor laser is scanned over the input facet of the wavelength conversion device along the second scanning axis, wherein the light emitted from the wavelength device as the output beam of the semiconductor laser is scanned along the second scanning axis comprises the first wavelength, the second wavelength, or both; and
align the output beam of the semiconductor laser with the waveguide portion of the wavelength conversion device based on the power of light measured as the output beam of the semiconductor laser is scanned along the second scanning axis.

19. The optical package of claim 18 wherein the at least one optical detector comprises a first optical detector positioned to measure the power of light emitted from an output facet of the wavelength conversion device and a second optical detector positioned to measure a power of light scattered from the wavelength conversion device.

20. The optical package of claim 18 where the at least one optical detector comprises a first optical detector operable to measure a first wavelength of light emitted from the output facet of the wavelength conversion device and a second optical detector operable to measure a second wavelength of light emitted from the wavelength conversion device; and
the optical package further comprises a dichroic beam splitter operable to direct light emitted from the wavelength conversion device having the first wavelength to the first optical detector and light emitted from the wavelength conversion device having the second wavelength to the second optical detector.
